(19) United States
(12) Patent Application Publication
(10) Pub. No.: US 2002/0149547 A1
(43) Pub. Date: Oct. 17, 2002

(54) Transparent programmable LED display panel and method

(76) Inventor: John A. Robertson, Chillicothe, OH (US)

Correspondence Address: MUELLER AND SMITH, LPA, MUELLER-SMITH BUILDING, 7700 RIVERS EDGE DRIVE, COLUMBUS, OH, 43235

(21) Appl. No.: 09/772,050

(22) Filed: Jan. 29, 2001

(51) Int. Cl. G09G 3/06

(52) U.S. Cl. 345/44; 345/82

(57) ABSTRACT

A programmable transparent display message center is formed from an array of rows and columns of light emitting diodes (LED's). A wire connects each row of LED's. Each column of LED's is connected to a conductive transparent layer. The transparent layer is electrically isolated from the rows of wires. A voltage drive is associated with each row and with each column.

### CROSS-REFERENCE TO RELATED APPLICATIONS

None.

### STATEMENT REGARDING FEDERALLY SPONSORED RESEARCH

Not applicable.

### BACKGROUND OF THE INVENTION

The present invention relates generally to displays and more particularly to a transparent display panel.

There is a need for an attention gabbing message center, which can be placed, for example, in a cooler door or window without greatly obscuring the view of the product inside the cooler. This is especially true when several brands are located within the same cooler. The marketing of the cooler contents demands that the items for sale be visible so that the customer can quickly locate the branded packages, which the manufacturer has otherwise aggressively marketed. On occasion, the store manager would like to display messages on the cooler door to attract the customers to special pricing and/or sale items.

Traditional Light Emitting Diode (LED) message centers are opaque; typically incorporating a fiberglass printed circuit board with copper traces. Placed in a cooler door, such traditional LED message centers unacceptably block the view of branded products. Thus, there is a need to create programmable message centers within a generally “transparent” panel.

While one could postulate a completely transparent programmable message center, practical conductive/transparent substrates have finite resistances, which preclude the practical fabrication of such a device. Consider a conventional array of LED's consisting of N rows and M columns, such as depicted in FIG. 1. An LED is connected at each “cross point”, as for example an LED, 212, at the intersection of N=3 and M=2. A complete display matrix consists of N×M such LED's, one at each crossover point. Utilizing a prior art drive (e.g., a time multiplexed drive such as is disclosed in U.S. Pat. No. 3,899,826) and transparent electrodes, it would appear that a solution to the transparent message center problem has been found. Unfortunately, the finite resistances mentioned above adversely impact this proposed device. Further reducing the glass' coating resistance does not help the problem because the glass begins to become more opaque, i.e., partially silvered, due to the increase in metal content of the coating required to increase its conductivity and reduce its resistivity.

As a practical example of the postulated completely transparent programmable message center, suppose that one wants to construct an array of height 5 cm consisting of 7 rows and 64 columns, and that the column pitch is ⅚ cm (square pixel cells) using indium tin oxide (ITO) sputter coated glass. Practical ITO coated glass has a surface resistivity of more than 2 Ω/square (sq) and the horizontal (Row) traces will, by necessity, be about ⅚ cm high (neglecting isolating line kerf). Each row would be driven typically for 1/N*100% of the time.

If the display were called on to simultaneously illuminate all 64 columns and the single average (design) typical surface mount LED current was, say, 10 ma, then each total row conductor current would be 64*N*10 ma=4.48 amp, which must be carried by a conductor having a resistivity of 2 Ω/sq*6/5*⅚=2.0 Ω between each pixel. An array as illustrated in FIG. 2 would have 64 LED's, illustrated by LED's 214-226, V_{drive} 228, a current source, 230, and resistors, 232-246. The current through each LED 214-226 would be 0.070 amps. If the array were driven from one end only by current 230, the conductor voltage drops can be calculated. Such calculated voltage drops are displayed in Table 1, below.

TABLE 1

| | Trace | Voltage | | Trace | Voltage |
|---|---|---|---|---|---|
| | Current | Drop | | Current | Drop |
| LED# | (A) | (V) | LED# | (A) | (V) |
| 1 | 0.07 | 0.14 | 33 | 2.31 | 4.62 |
| 2 | 0.14 | 0.28 | 34 | 2.38 | 4.76 |
| 3 | 0.21 | 0.42 | 35 | 2.45 | 4.9 |
| 4 | 0.28 | 0.56 | 36 | 2.52 | 5.04 |
| 5 | 0.35 | 0.7 | 37 | 2.59 | 5.18 |
| 6 | 0.42 | 0.84 | 38 | 2.66 | 5.32 |
| 7 | 0.49 | 0.98 | 39 | 2.73 | 5.46 |
| 8 | 0.56 | 1.12 | 40 | 2.8 | 5.6 |
| 9 | 0.63 | 1.26 | 41 | 2.87 | 5.74 |
| 10 | 0.7 | 1.4 | 42 | 2.94 | 5.88 |
| 11 | 0.77 | 1.54 | 43 | 3.01 | 6.02 |
| 12 | 0.84 | 1.68 | 44 | 3.08 | 6.16 |
| 13 | 0.91 | 1.82 | 45 | 3.15 | 6.3 |
| 14 | 0.98 | 1.96 | 46 | 3.22 | 6.44 |
| 15 | 1.05 | 2.1 | 47 | 3.29 | 6.58 |
| 16 | 1.12 | 2.24 | 48 | 3.36 | 6.72 |
| 17 | 1.19 | 2.38 | 49 | 3.43 | 6.86 |
| 18 | 1.26 | 2.52 | 50 | 3.5 | 7 |
| 19 | 1.33 | 2.66 | 51 | 3.57 | 7.14 |
| 20 | 1.4 | 2.8 | 52 | 3.64 | 7.28 |
| 21 | 1.47 | 2.94 | 53 | 3.71 | 7.42 |
| 22 | 1.54 | 3.08 | 54 | 3.78 | 7.56 |
| 23 | 1.61 | 3.22 | 55 | 3.85 | 7.7 |
| 24 | 1.68 | 3.36 | 56 | 3.92 | 7.84 |
| 25 | 1.82 | 3.64 | 57 | 3.99 | 7.98 |
| 26 | 1.83 | 3.64 | 58 | 4.06 | 8.12 |
| 27 | 1.89 | 3.78 | 59 | 4.13 | 8.26 |
| 28 | 1.96 | 3.92 | 60 | 4.2 | 8.4 |
| 29 | 2.03 | 4.06 | 61 | 4.27 | 8.54 |
| 30 | 2.1 | 4.2 | 62 | 4.34 | 8.68 |
| 31 | 3.17 | 4.34 | 63 | 4.41 | 8.82 |
| 32 | 2.24 | 4.48 | 64 | 4.48 | 8.96 |

| Driven at One End | 73.92 | Driven at Both Ends | 291.2 |
|---|---|---|---|
| | volts | | volts |

Thus, a total drive voltage, 228, (V_{drive}) of more than 290 volts would be required. This amount of voltage could be decreased to about 74 volts by driving the display from both ends. In either case, however, the design would be very complex and impractical in that both the row drive voltage and the cathode sink current for each column would have to be dynamically varied as the display pattern changes.

This voltage problem does not appear in the art because the (opaque/printed board) trace resistances either are small enough to ignore or they can be compensated for using (very small) fixed series resistances.

### BRIEF SUMMARY OF THE INVENTION

A programmable transparent display message center is formed from an array of rows and columns of light emitting diodes (LED's). A wire connects each row of LED's. Each column of LED's is connected to a conductive transparent layer. The transparent layer is electrically isolated from the rows of wires. A voltage driver and controller is associated with said array. For present purposes, a display message center is “transparent” to a viewer if it uses transparent components and/or components that are of such a size that the viewer would not be hindered in viewing objects behind the display message center. A message display center is transparent for present purposes if only a portion of the display center is transparent and another section of the display center is not transparent.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a conventional array of LED's consisting of N rows and M columns showing an LED at one cross over point;

FIG. 2 is a representation of a prior art array of 64 LED's for calculating the voltage required to drive, V_{drive}, the array;

FIG. 3 is an illustrative embodiment of the programmable transparent message display center;

FIG. 4 depicts a single column land associated with 7 rows in order to illustrate both the Anode Drive Level Changes embodiment of constructing a programmable transparent message display center and the Constant Anode Drive Level with ON Time Consumption embodiment of constructing a programmable transparent message display center;

FIG. 5 represents the drive and logic signals to illuminate rows 1, 4, and 6 for the Anode Drive Level Changes embodiment of FIG. 4;

FIG. 6 represents the drive and logic signals to illuminate rows 1, 4, and 6 for the Constant Anode Drive Level with ON Time Consumption embodiment;

FIG. 7 is a programmable transparent message display center embodiment constructed in accordance with the invention; and

FIG. 8 is another programmable transparent message display center embodiment constructed in accordance with the invention.

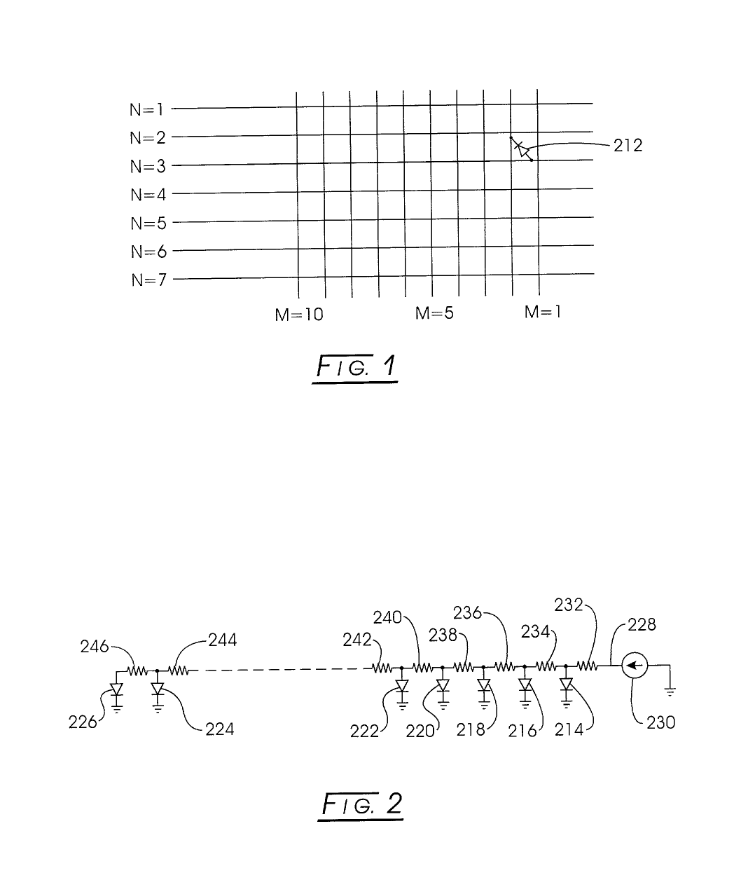

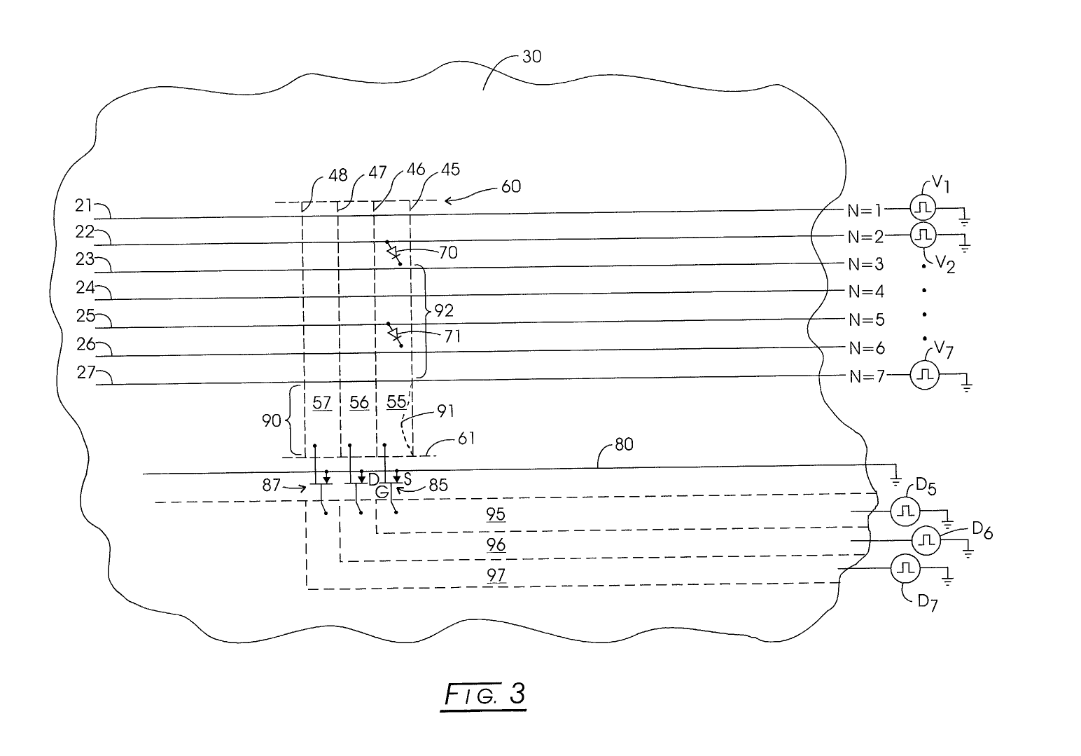

### DETAILED DESCRIPTION OF THE INVENTION

The invention is based on a hybrid solution to the problem outlined above. To that end, each row conductor of the LED array consists of a thin diameter, low resistance wire (e.g., copper, silver). Using good conductors for the row traces, which must simultaneously drive many columns means that the end to end row voltage drop can be made small, e.g., 4.48 A*0.1 Ω=0.448 V for a 64*⅚=53 cm long display using #28 copper or silver wire.

With respect to the columns, integrated circuit column drivers and control circuitry cannot be distributed along the display as is typical in the prior art (printed circuit design), as the transparency of the display would be unacceptably compromised and reduced. If simple connections to conductive traces leading from the display ends to the columns were made, voltage problems again would be faced. For example, a multiplexed 0.07 amp cathode column current through a 5/32″ wide trace of 2 Ω per square ITO glass would have a voltage drop of about 0.9 V/cm or about 24 V to get to the example display center. Again, driving circuitry would need to be necessarily complex if the current is to be balanced in all pixels in a given column.

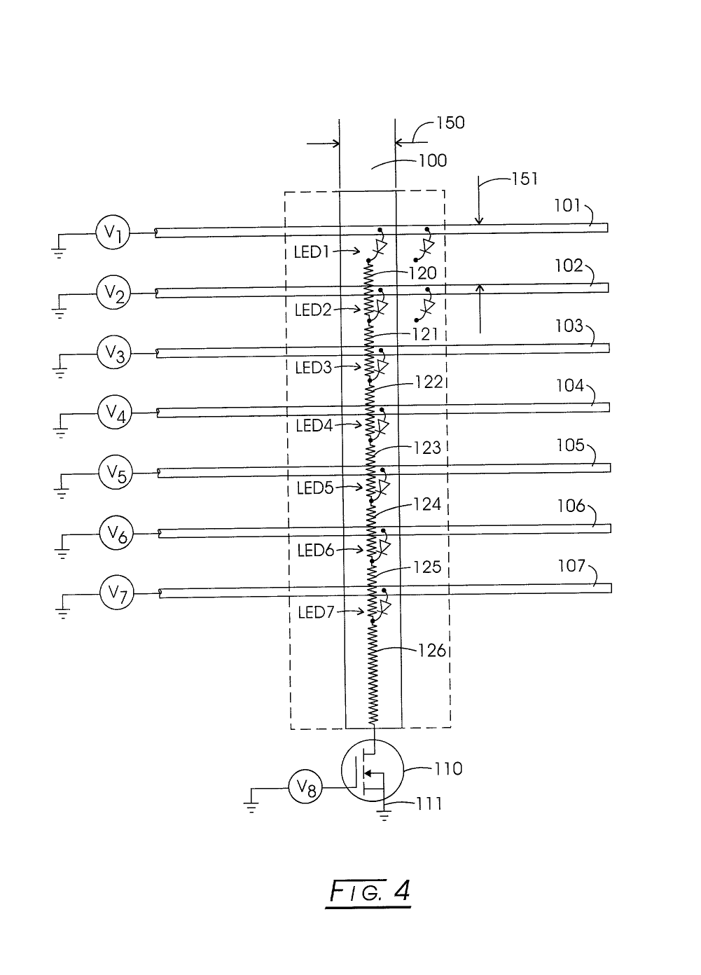

In order to inventionally solve this problem, reference is made to FIG. 3, which depicts one embodiment of a display panel. Anode (time multiplexed) voltages, V1 through V7, are applied to row wires, 21 through 27, respectively. Wires 21-27 lie atop a conducting, transparent sheet, 30, but are insulated (gapped from) sheet 30.

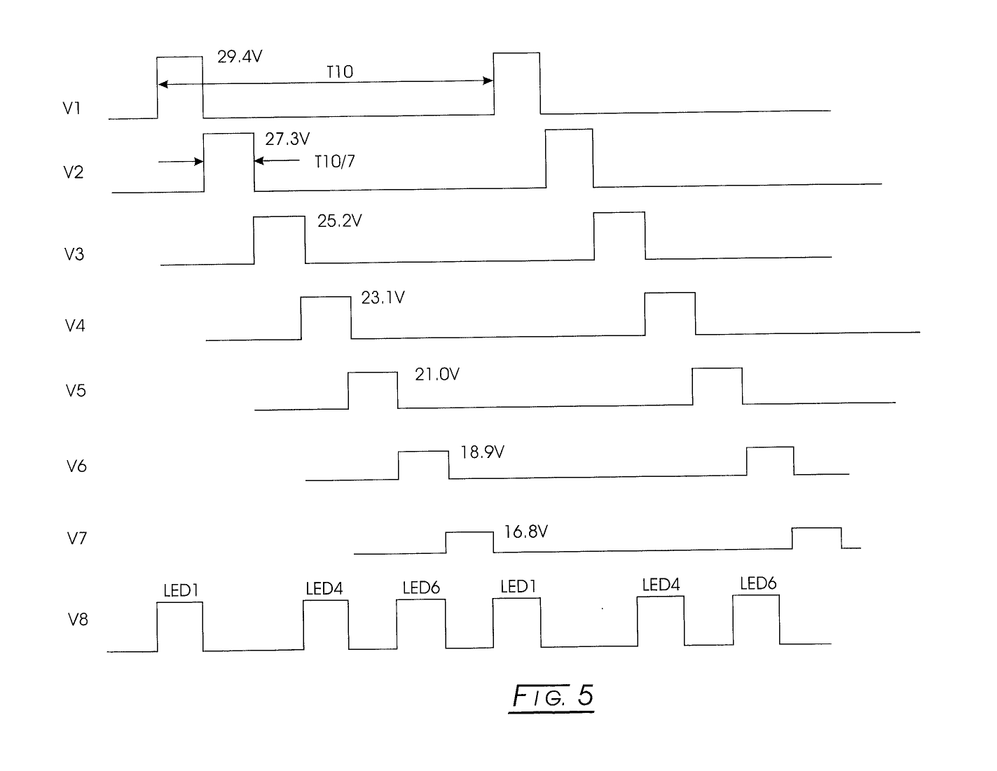

For illustrative purposes only and not by way of limitation, only 3 columns and 2 LED's are shown in FIG. 4. Lines, 45-48, are (laser) cut lines in the conductive surface of sheet 30, which produce isolated conductive lands, 55-57, in conductive sheet 30. A cut line, 60, isolates lands 55-57 at the top and a second cut line, 61, isolates lands or bars 55-57 at the bottom. Individual (surface mount) LED's, as represented as 70 and 71, are connected so that the anode is connected to a wire, such as wire 22 for LED 70, and the cathode is connected to the conductive coating of land 55.

A wire, 80, provides a high current path for all LED cathodes and is connected to the sources of column driver FETs (field effect transistors), 85 through 87, whose gates are driven via isolated conductive paths, 95 through 97, respectively. Conductive paths 95-97 are formed by cutting the conductive layer of sheet 30 and are driven by data (logic) signals, represented as D5 through D7, respectively.

The areas of sheet 30 identified by numeral 90 in each cathode drive bar lands 55 through 57 provide a minimum protective series resistance for each LED. Area 90, then, may be made narrow to increase this series resistance, such as, for example, as depicted by dashed lines 91.

The column resistance for the representative LED 70 also includes the conductive column resistance identified by numeral 92. Thus, diode 70 will receive less current than LED 71, because LED 70 is located a greater distance (i.e., resistance) from cut line 61. To balance the display row currents, the ON time for voltage source V1 can be made longer than the ON time for voltage source V2, etc. This scheme will be described in more detail below in connection with the “Constant Anode Drive level with ON time compensation” embodiment. Alternatively (and with additional complexity), the anode (row wire) voltages may differ for each row as will be described in more detail below in connection with the “Anode Drive Level Changes” embodiment.

Column drive transistors 85-87 also are very small surface mount devices and all isolating cuts within conductive sheet 30 are quite thin (e.g., about 0.1 mm wide) and nearly invisible. The result is a nearly transparent, attention grabbing display, which does not obscure the product behind it.

Anode Drive Level Changes

As stated above, the resistivity of practical glass coatings (e.g., ITO, pyrolytic tin oxide) lies in the range of about 10 to 100 Ω/square (dimensionless). This means that a 0.25″ wide (column) conductor strip (land) has a resistance of between about 40 and 400 Ω/linear inch. Referring to FIG. 4, a single column land, 100, is seen to be connected to 7 LED's, LED1-LED7. In a complete message center there may be, say between about 40 and 64 such column lands. The anode of each LED is connected to the (negligible resistance) wires, 101-107, respectively. The cathodes of each LED is bonded to the (resistive) coating in column land 100, which is switched to a common (wire connected) ground, 111, by an N channel FET, 110. The controlling gate signal for FET 110 is identified by numeral V8.

The resistivity of column land 100 is illustrated schematically in FIG. 4 by a series of 6 segment additive resistances identified by numerals 120-125, and an additional protective, connective resistance, 126, leading to a switching column driver, 110, whose ON resistance can be ignored.

By way of example, assume that the resistivity of column land 100 is 30 Ω/square and that its width is 0.25″. Also assume that the spacing between anode wires 101-107 also is 0.25″, thus producing 0.25″/side square pixel spacing in the resultant display.

The Anode Drive Level Changes embodiment, then, utilizes multiplexed anode (row) drive signals, V1-V8 (N=1 to 8), which can be sequenced with equal ON times for each row and higher levels on signal V1 than for signal V2, which is higher than signal V3, etc.

For the assumed values, the resistance of resistances 120-125 equals 30 Ω/square*0.25″/0.25″=30 Ω each. Now, supposed that resistance 126 results from a 2.0″ length of column land 100. This means that resistance 126 equals 30 Ω/square*2.0″/0.25″=240 Ω. Equal ON times, thus, require a peak row current equal to 7 resistances*0.010 amps=0.70 amps. This means that Vx (x=1-7)=0.070 amps*(240 Ω+30 Ω/square*(7−N)) volts. Thus, the voltage for each Vx is as follows:

V1=29.4 volts

V2=27.3 volts

V3=25.2 volts

V4=23.1 volts

V5=21.0 volts

V6=18.9 volts

V7=16.8 volts.

FIG. 5 represents the drive and logic signals to illuminate rows 1, 4, and 6. Note should be taken that the scan time shown as T10 must be less than 1/30 sec to avoid the appearance of display flicker to the human eye.

Constant Anode Drive Level with ON Time Compensation

Using the same physical resistances as in the Anode Drive Level Changes embodiment above, V7 is 16.8 volts and is applied for T7 seconds. Thus, the following times can be calculated:

$$\begin{matrix}T7 = 1.0 * T7 \\ T6 = 1.125 * T7 \\ T5 = 1.250 * T7 \\ T4 = 1.375 * T7 \\ T3 = 1.500 * T7 \\ T2 = 1.635 * T7 \\ T1 = \frac{1.750}{9.625} * T7\end{matrix}$$

The total time for all rows to be multiplexed in this example, then, is 9.625*Timax (flicker)=9.625*1/30 sec (persistence of vision). Thus, T7 should be less than 3.5 msec.

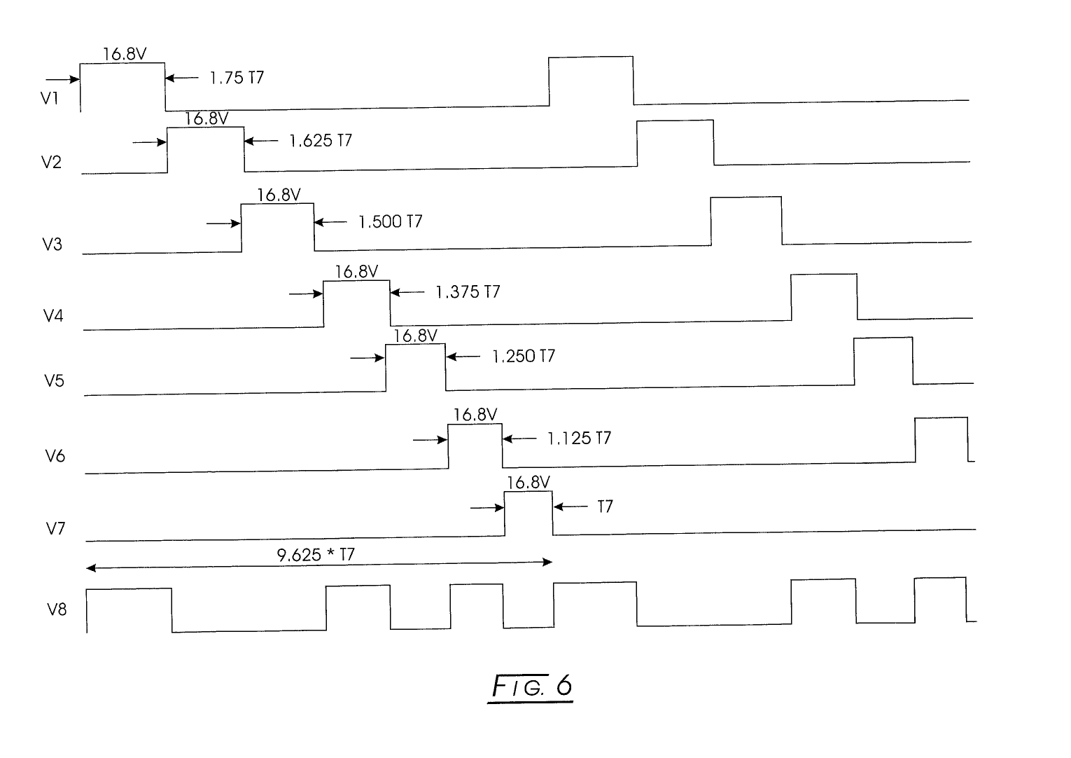

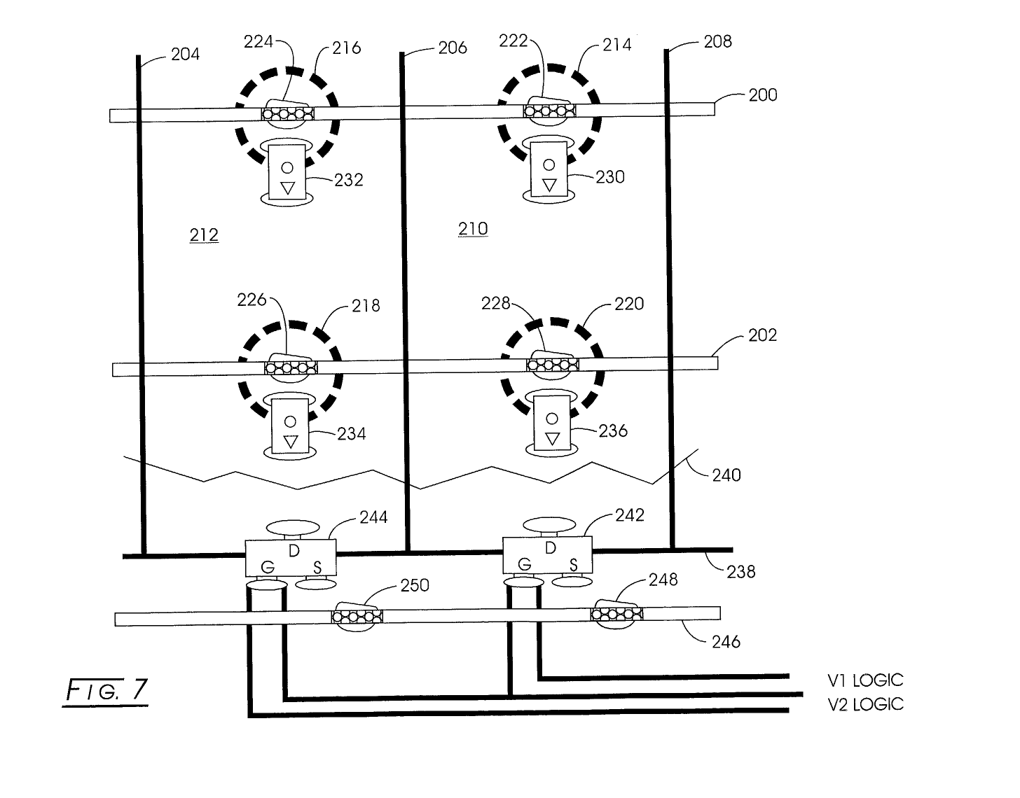

FIG. 6 represents the drive and logic signals to illuminate rows 1, 4, and 6 using on time compensation. Note should be taken that the period of the logic signals must match the (differing) row pulse widths.

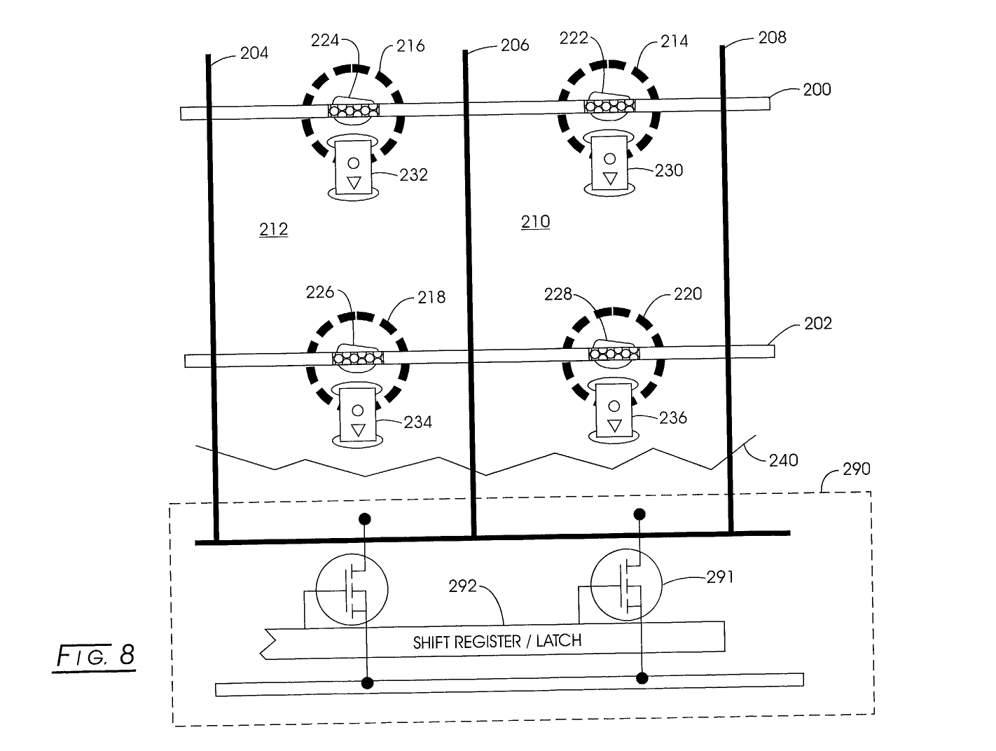

A section of a transparent display message center constructed in accordance with the precepts of the present invention is illustrated in FIG. 7. In particular thin (e.g., #28) copper wire rows, 200 and 202, along with laser cut lines, 204-208, which form column land conductors, 210 and 212, which are formed from ITO coated glass (e.g., 1 micron thickness ITO layer). Again, the actual display constructed consisted of 7 rows and 64 columns, with only a section of this display being illustrated in FIG. 7. Associated mesas, 214-220, are laser cut in the ITO to isolate such mesas within their respective columns. A conductive epoxy, identified by numerals 222-228, attaches row wire 200 or 202 to their respective mesas. Surface mount LEDS (e.g., LNJ208R8ARA LED manufactured by Panasonic of Japan), 230-236, are attached to each mesa 214-220 at one end and to their respective columns at the other end. Voltage drives associated with each wire 200 and 202 are not shown, but are provided. A laser cut line, 238, terminates the length of column lands 210 and 212. The terminal resistance, which can be varied by physical design, of each column land 210, 212, is shown generally by numeral 240. FET's, 242 and 244, are associated respectively with column lands 210 and 212. The source (S), gate (G), and drain (D) are connected in conventional fashion. A ground wire, 246, is electrically coupled to the ITO coated glass by conductive epoxy, such as identified by numerals 248 and 250. Logic to FET's 242 and 244 are represented as V1 Logic and V2 Logic. The size of each pixel is 0.25″ (ignoring kerf). The FETs and associated LED's and conductive adhesive spots represent an opaque areas, but should not objectionably interfere with the otherwise transparent display message center manufactured as shown in FIG. 7.

FIG. 8 shows a second and preferred embodiment of a section of a transparent display message center constructed in accordance with the precepts of the present invention. The construction of the column and rows in this second embodiment is the same as the construction described in connection with FIG. 7. Here, however, column drives for each column consist of a sinking driver, 291, controlled by a control shift register/latch data, 292, located in a thin, opaque block, 290, at one edge of the otherwise nearly transparent display. Similar column drivers are associated with each column. Although opaque block 290 detracts somewhat from the otherwise nearly transparent display, block 290 can be positioned over a cooler shelf edge and, thereby still not obscure the produce on display in the cooler. The LED message still appears “magically” in a nearly clear area and the point of purchase attention is gleaned.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

1. A programmable transparent display message center, which comprises:
(a) an array of rows and columns of light emitting diodes (LED's);
(b) each row of said LED's connected by a wire;
(c) each column of said LED's connected to a conductive transparent layer, said transparent layer being electrically isolated from said rows of wires; and
(d) a multiplexed voltage driver and sequenced controller associated with said array.
